(19) United States
(12) Patent Application Publication
(10) Pub. No.: US 2021/0333387 A1
(43) Pub. Date: Oct. 28, 2021

(54) MEASURING DEVICE, MEASURING METHOD, AND COMPUTER READABLE MEDIUM

(71) Applicant: Mitsubishi Electric Corporation, Tokyo (JP)

(72) Inventors: Kimihiko HIROI, Tokyo (JP); Ryota SEKIGUCHI, Tokyo (JP)

(73) Assignee: Mitsubishi Electric Corporation, Tokyo (JP)

(21) Appl. No.: 17/367,063

(22) Filed: Jul. 2, 2021

Related U.S. Application Data
(63) Continuation of application No. PCT/JP2019/032538, filed on Aug. 21, 2019.

(30) Foreign Application Priority Data
Jan. 30, 2019 (JP) PCT/JP2019/003097

(51) Int. Cl. G01S 13/66; G01S 17/89; G01S 17/08; G01S 13/89; G01S 13/86

(52) U.S. Cl. CPC G01S 13/66; G01S 17/89; G01S 13/865; G01S 13/89; G01S 17/08

(57) ABSTRACT

A tracking unit (21) takes, as a subject sensor, each of a plurality of sensors, and calculates a detection value at a subject time about a detection item of an object by using a Kalman filter, on the basis of an observation value about the detection item of the object, the observation value being obtained by observing the object with the subject sensor at the subject time. A reliability calculation unit (23) calculates a reliability of the detection value that is calculated on the basis of the subject sensor, by using a Kalman gain in addition to a Mahalanobis distance between the observation value obtained with the subject sensor and a prediction value that is a value of the detection item of the object at the subject time which is predicted at a time before the subject time. A value selection unit (24) selects a high-reliability detection value among the detection values based on the plurality of sensors.

### CROSS REFERENCE TO RELATED APPLICATIONS

This application is a Continuation of PCT International Application No. PCT/JP2019/032538, filed on Aug. 21, 2019, which claims priority under 35 U.S.C. 119(a) to Patent Application No. PCT/JP2019/003097, filed in Japan on Jan. 30, 2019, all of which are hereby expressly incorporated by reference into the present application.

### TECHNICAL FIELD

The present invention relates to a technique of calculating a detection value of a detection item of an object using a plurality of sensors.

### BACKGROUND ART

There is a technique that controls a vehicle by identifying a detection value of a detection item such as a position and velocity of an object in the vicinity of the vehicle, using a plurality of sensors mounted in the vehicle.

This technique sometimes judges whether or not objects detected by the individual sensors are the same. In this judgment, it is judged whether or not vectors each having, as elements, values of individual detection items about the objects detected by the individual sensors are similar, thereby judging whether or not the objects detected by the individual sensors are the same.

Patent Literature 1 describes how a likelihood between a position calculated from data obtained with a sensor and a position indicated by map data is calculated using a Mahalanobis distance.

### CITATION LIST

### Patent Literature

Patent Literature 1: JP 2011-002324 A

### SUMMARY OF INVENTION

### Technical Problem

When it is judged that objects detected by a plurality of sensors are the same, it is necessary to identify a detection value of each detection item of the object. At this time, a likely vector would be selected from among vectors each having, as elements, values of individual detection items about the objects detected by the individual sensors, and a value of each detection item indicated by the selected vector would be considered as a detection value. Unless likelihood of the vector is calculated appropriately, the detection value of each detection item about the object cannot be identified appropriately.

An objective of the present invention is to make it possible to appropriately identify the detection value of the detection item about the object.

### Solution to Problem

A measuring device according to the present invention includes:

a tracking unit to take, as a subject sensor, each of a plurality of sensors, and to calculate a detection value at a subject time about a detection item of an object by using a Kalman filter, on a basis of an observation value about the detection item of the object, the observation value being obtained by observing the object with the subject sensor at the subject time;

a reliability calculation unit to take, as a subject sensor, each of the plurality of sensors, and to calculate a reliability of the detection value that is calculated on the basis of the observation value obtained with the subject sensor, by using a Kalman gain in addition to a Mahalanobis distance between the observation value and a prediction value, the observation value being obtained with the subject sensor, the prediction value being a value of the detection item of the object at the subject time which is predicted at a time before the subject time, the prediction value being used in calculation of calculating the detection value by the tracking unit on the basis of the observation value, the Kalman gain being obtained in the calculation; and

a value selection unit to select a detection value whose reliability calculated by the reliability calculation unit is high among the detection values which are calculated on the basis of the observation values obtained by the plurality of sensors.

### Advantageous Effects of Invention

In the present invention, from among detection values calculated on the basis of a plurality of sensors, a detection value whose reliability calculated from the Mahalanobis distance and the Kalman gain is high is selected. This makes it possible to select an appropriate detection value in consideration of both a high reliability of most recent information and a high reliability of time-series information.

### BRIEF DESCRIPTION OF DRAWINGS

FIG. 1 is a configuration diagram of a measuring device 10 according to Embodiment 1.

FIG. 2 is a flowchart illustrating operations of the measuring device 10 according to Embodiment 1.

FIG. 3 is an explanatory diagram of the operations of the measuring device 10 according to Embodiment 1.

FIG. 4 is a configuration diagram of a measuring device 10 according to Modification 1.

FIG. 5 is a configuration diagram of a measuring device 10 according to Embodiment 2.

FIG. 6 is a flowchart illustrating operations of the measuring device 10 according to Embodiment 2.

FIG. 7 is an explanatory diagram of a lap ratio according to Embodiment 2.

FIG. 8 is an explanatory diagram of a lap ratio calculation method according to Embodiment 2.

FIG. 9 is an explanatory diagram of a TTC calculation method according to Embodiment 2.

FIG. 10 is a diagram illustrating specific examples of a Kalman gain according to Embodiment 3.

FIG. 11 is a diagram illustrating specific examples of a Mahalanobis distance according to Embodiment 3.

FIG. 12 is a diagram illustrating specific examples of a reliability according to Embodiment 3.

FIG. 13 is a diagram illustrating specific examples of detection values according to Embodiment 3.

### DESCRIPTION OF EMBODIMENTS

### Embodiment 1

***Description of Configuration***

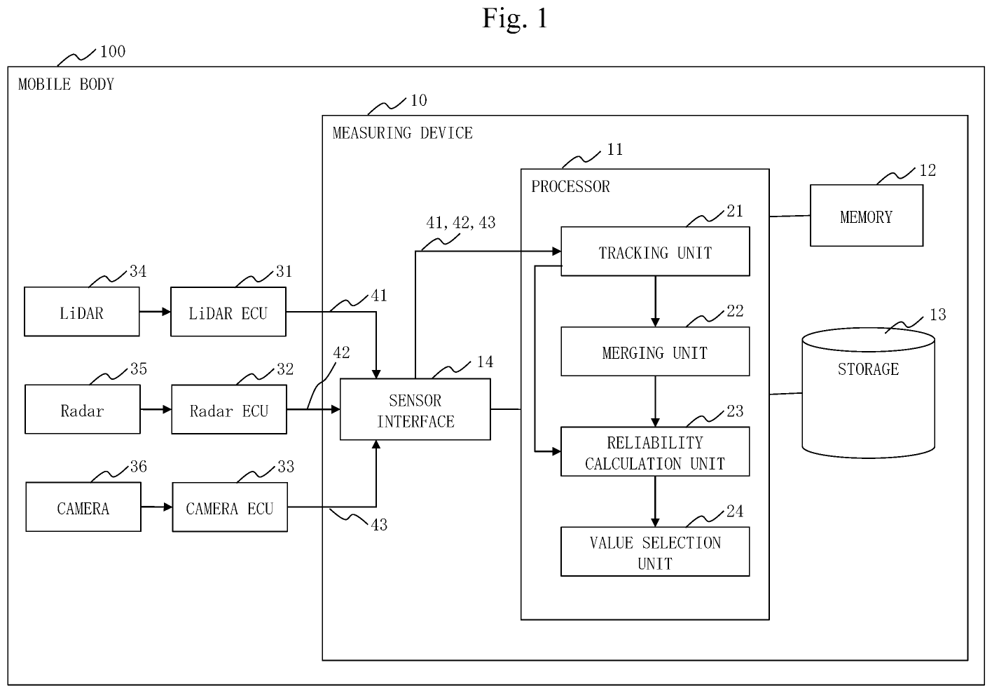

A configuration of a measuring device 10 according to Embodiment 1 will be described with referring to FIG. 1.

The measuring device 10 is a computer mounted in a mobile body 100 to calculate a detection value about an object in the vicinity of the mobile body 100. In Embodiment 1, the mobile body 100 is a vehicle. The mobile body 100 is not limited to a vehicle but may be of another type such as vessel.

The measuring device 10 may be mounted to be integral with or inseparable from the mobile body 100 or another constituent element illustrated. Alternatively, the measuring device 10 may be mounted to be removable or separable from the mobile body 100 or another constituent element illustrated.

The measuring device 10 is provided with hardware devices which are a processor 11, a memory 12, a storage 13, and a sensor interface 14. The processor 11 is connected to the other hardware devices via a signal line and controls the other hardware devices.

The processor 11 is an Integrated Circuit (IC) that performs processing. Specific examples of the processor 11 include a Central Processing Unit (CPU), a Digital Signal Processor (DSP), and a Graphics Processing Unit (GPU).

The memory 12 is a storage device that stores data temporarily. Specific examples of the memory 12 include a Static Random-Access Memory (SRAM) and a Dynamic Random-Access Memory (DRAM).

The storage 13 is a storage device that keeps data. Specific examples of the storage 13 include a Hard Disk Drive (HDD). Alternatively, the storage 13 may be a portable recording medium such as a Secure Digital (SD; registered trademark) memory card, a CompactFlash (registered trademark; CF), a NAND flash, a flexible disk, an optical disk, a compact disk, a Blu-ray (registered trademark) Disc, and a Digital Versatile Disk (DVD).

The sensor interface 14 is an interface to be connected to a sensor. Specific examples of the sensor interface 14 include an Ethernet (registered trademark) port, a Universal Serial Bus (USB) port, and a High-Definition Multimedia Interface (HDMI; registered trademark) port.

In Embodiment 1, the measuring device 10 is connected to a Laser Imaging Detection and Ranging (LiDAR) Electronic Control Unit (ECU) 31, a Radar ECU 32, and a camera ECU 33 via the sensor interface 14.

The LiDAR ECU 31 is a device that is connected to a LiDAR 34 being a sensor mounted in the mobile body 100 and that calculates an observation value 41 of an object from sensor data obtained with the LiDAR 34. The Radar ECU 32 is a device that is connected to a Radar 35 being a sensor mounted in the mobile body 100 and that calculates an observation value 42 of an object from sensor data obtained with the Radar 35. The camera ECU 33 is a device that is connected to a camera 36 being a sensor mounted in the mobile body 100 and that calculates an observation value 43 of an object from image data obtained with the camera 36.

The measuring device 10 is provided with a tracking unit 21, a merging unit 22, a reliability calculation unit 23, and a value selection unit 24, as function constituent elements. Functions of the function constituent elements of the measuring device 10 are implemented by software.

A program that implements the functions of the function constituent elements of the measuring device 10 is stored in the storage 13. This program is read into the memory 12 by the processor 11 and executed by the processor 11. Hence, the functions of the function constituent elements of the measuring device 10 are implemented.

In FIG. 1, only one processor 11 is illustrated. However, there may be a plurality of processors 11, and the plurality of processors 11 may cooperate with each other to execute the program that implements the functions.

***Description of Operations***

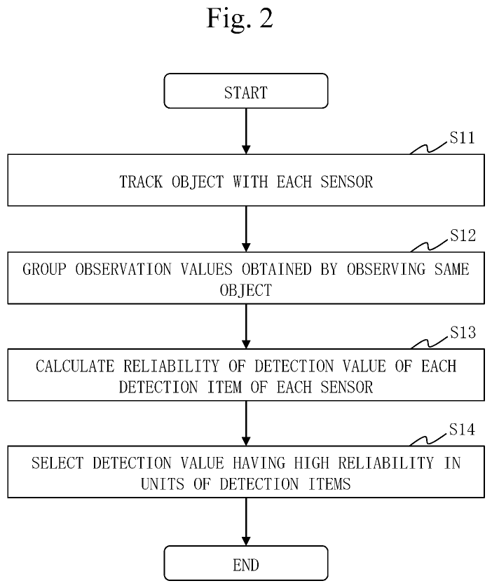

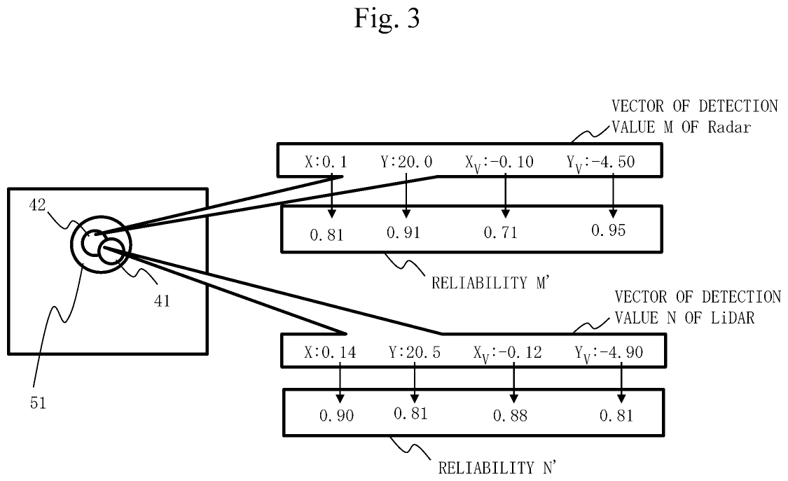

Operations of the measuring device 10 according to Embodiment 1 will be described with referring to FIGS. 2 and 3.

The operations of the measuring device 10 according to Embodiment 1 correspond to a measuring method according to Embodiment 1. Also, the operations of the measuring device 10 according to Embodiment 1 correspond to processing of a measuring program according to Embodiment 1.

(Step S11 of FIG. 2: Tracking Process) The tracking unit 21 takes each of a plurality of sensors as a subject sensor, and obtains an observation value about each of a plurality of detection items of an object, the observation value being obtained by observing the object existing in the vicinity of a mobile body 100 with the subject sensor at a subject time. Then, on the basis of the observation values, the tracking unit 21 calculates detection values at the subject time about each of the plurality of detection items of the object using a Kalman filter.

In Embodiment 1, the sensors are the LiDAR 34, the Radar 35, and the camera 36. The sensors are not limited to these sensors but may include another sensor such as a sound wave sensor. In Embodiment 1, the detection items are a horizontal-direction position X, a depth-direction position Y, a horizontal-direction velocity Xv, and a depth-direction velocity Yv. The detection items are not limited to these items but may include another item such as a horizontal-direction acceleration and a depth-direction acceleration.

Specifically, the tracking unit 21 acquires the observation value 41 of each detection item based on the LiDAR 34, from the LiDAR ECU 31. The tracking unit 21 also acquires the observation value 42 of each detection item based on the Radar 35, from the Radar ECU 32. The tracking unit 21 also acquires the observation value 43 of each detection item based on the camera 36, from the camera ECU 33. Each of the observation values 41, 42, and 43 expresses a horizontal-direction position X, a depth-direction position Y, a horizontal-direction velocity Xv, and a depth-direction velocity Yv. The tracking unit 21 takes each of the LiDAR 34, the Radar 35, and the camera 36, as a subject sensor and takes as input an observation value (the observation value 41, the observation value 42, or the observation value 43) based on the subject sensor, and calculates a detection value of each detection item using the Kalman filter.

According to a specific example, the tracking unit 21 calculates the detection value about a subject detection item of the subject sensor, using a Kalman filter for an object motion model indicated by Expression 1 and an object observation model indicated by Expression 2.

X_{t|t-1}=F_{t|t-1}·X_{t-1|t-1}+G_{t|t-1}·Uₜ₋₁ [Expression 1]

Zₜ=Hₜ·X_{t|t-1}+Vₜ [Expression 2]

Note that X_{t|t-1} is a state vector for a time t at a time t−1. F_{t|t-1} is a transition matrix for a time t−1 to a time t. X_{t-1|t-1} is a present value of a state vector of the object at the time t−1. G_{t|t-1} is a driving matrix for the time t−1 to the time t. Uₜ₋₁ is a system noise vector following a normal distribution, whose average at the time t−1 is 0, of a covariance matrix Qₜ₋₁. Zₜ is an observation vector expressing an observation value of the sensor at the time t. Hₜ is an observation function at the time t. Vₜ is an observation noise vector following a normal distribution, whose average at the time t is 0, of a covariance matrix Rₜ.

When an expanded Kalman filter is used, the tracking unit 21 calculates a detection value by executing predictive processing indicated by Expressions 3 and 4 and smoothing processing indicated by Expressions 5 to 10, for the subject detection item of the subject sensor.

\hat{X}_{t|t-1}=F_{t|t-1}·\hat{X}_{t-1|t-1} [Expression 3]

P_{t|t-1}=F_{t|t-1}·P_{t-1|t-1}·F_{t|t-1}^{T}+G_{t|t-1}·Qₜ₋₁·G_{t|t-1}^{T} [Expression 4]

Sₜ=Hₖ·P_{t|t-1}·Hₖ^{T}+Rₜ [Expression 5]

\tilde{Z}ₜ=Zₜ−Hₜ·\hat{X}_{t|t-1} [Expression 6]

θₜ\sqrt{\tilde{Z}ₜ^{T}Sₜ⁻¹\tilde{Z}ₜ}[Expression 7]

Kₜ=P_{t|t-1}·Hₜ^{T}·Sₜ⁻¹[Expression 8]

\hat{X}_{t|t}=\hat{X}_{t|t-1}+Kₜ·\tilde{Z}ₜ [Expression 9]

P_{t|t}=(I−Kₜ·Hₜ)·P_{t|t-1} [Expression 10]

Note that: X\hat{ }_{t|t-1} is a predictive vector for the time t at the time t−1; X\hat{ }_{t|t-1} is a smoothing vector at the time t−1; P_{t|t-1} is a predictive error covariance matrix for the time t at the time t−1; P_{t-1|t-1} is a smoothing error covariance matrix at the time t−1; Sₜ is a residual covariance matrix at the time t; θₜ is a Mahalanobis distance at the time t; Kₜ is a Kalman gain at the time t; X\hat{ }_{t|t} is a smoothing vector at the time t and expresses a detection value of each detection item at the time t; P_{t|t} is a smoothing error covariance matrix at the time t; and I is an identity matrix. T expressed as a superscript to a matrix indicates that the matrix is a transposed matrix, and −1 expressed as a superscript to a matrix indicates that the matrix is an inverse matrix.

The tracking unit 21 writes to the memory 12 various types of data obtained by calculation, such as the Mahalanobis distance θₜ, the Kalman gain Kₜ, and the smoothing vector X\hat{ }_{t|t} at the time t.

(Step S12 of FIG. 2: Merging Process)

The merging unit 22 calculates Mahalanobis distances among observation values at a subject time based on the sensors. In Embodiment 1, the merging unit 22 calculates a Mahalanobis distance between an observation value based on the LiDAR 34 and an observation value based on the Radar 35, a Mahalanobis distance between an observation value based on the LiDAR 34 and an observation value based on the camera 36, and a Mahalanobis distance between an observation value based on the Radar 35 and an observation value based on the camera 36. A Mahalanobis distance calculation method is different from a Mahalanobis distance of step S11 only in data as a calculation subject.

When the Mahalanobis distances are equal to or less than a threshold, the merging unit 22 considers observation values obtained with the two sensors, as observation values obtained by observing the same object, and classifies the observation values obtained with the two sensors under the same group.

It is possible that the Mahalanobis distance between the observation value based on the LiDAR 34 and the observation value based on the Radar 35, and the Mahalanobis distance between the observation value based on the LiDAR 34 and the observation value based on the camera 36 are each equal to or less than the threshold, and that the Mahalanobis distance between the observation value based on the Radar 35 and the observation value based on the camera 36 is longer than the threshold. In this case, when seen from relation with the observation value based on the LiDAR 34, the observation value based on the LiDAR 34, the observation value based on the Radar 35, and the observation value based on the camera 36 are observation values obtained by detecting the same object. However, when seen from relation with the observation value based on the Radar 35, while the observation value based on the Radar 35 and the observation value based on the LiDAR 34 are observation values obtained by detecting the same object, the observation value based on the Radar 35 and the observation value based on the camera 36 are observation values obtained by detecting different objects.

In that case, a judging criterion may be decided in advance, and the merging unit 22 may judge that observation values based on which sensors are observation values obtained by detecting the same object, according to the judging criterion. The judging criterion may be that, for example, if certain observation values are observation values obtained by detecting the same object when seen from relation with an observation value based on one sensor, then the certain observation values are considered to be observation values obtained by detecting the same object. Alternatively, the judging criterion may be that, for example, certain observation values are considered to be observation values obtained by detecting the same object, only if the certain observation values are observation values obtained by detecting the same object when seen from relation with observation values that are based on all sensors.

(Step S13 of FIG. 2: Reliability Calculation Process)

The reliability calculation unit 23 takes each of the plurality of sensors as a subject sensor and each of a plurality of detection items as a subject detection item, and calculates a reliability of the detection value of the subject detection item, the detection value being calculated in step S11 on the basis of the observation value by the subject sensor.

Specifically, the reliability calculation unit 23 acquires a Mahalanobis distance between the observation value of the subject detection item obtained in step S11 with the subject sensor, and a prediction value that is a value of a detection item of an object at a subject time. The prediction value, used in step S11 in calculation of calculating the detection value on the basis of this observation value, is predicted at a time before the subject time. That is, the reliability calculation unit 23 reads and acquires, from the memory 12, the Mahalanobis distance θₜ which is calculated in step S11 when X\hat{ }_{t|t} is calculated. The reliability calculation unit 23 also acquires the Kalman gain that has been obtained in step S11 in calculation of calculating the detection value on the basis of the observation value of the subject detection item with the subject sensor. That is, the reliability calculation unit 23 reads and acquires from the memory 12 the Kalman gain Kₜ which is calculated in step S11 when X\hat{ }_{t|t} is calculated.

The reliability calculation unit 23 calculates the reliability of the detection value of the subject detection value, which is calculated on the basis of the observation value by the subject sensor, using the Mahalanobis distance θₜ and the Kalman gain Kₜ. Specifically, the reliability calculation unit 23 calculates the reliability of the detection value of the subject detection item, which is calculated on the basis of the observation value by the subject sensor, by multiplying the Mahalanobis distance θₜ by the Kalman gain Kₜ, as illustrated by Expression 11.

$$[ \begin{matrix}{M}_{X} \\ {M}_{Y} \\ {M}_{Xv} \\ {M}_{Yv}\end{matrix} ] = [ \begin{matrix}{K}_{X} & & & \\ & {K}_{Y} & & \\ & & {K}_{Xv} & \\ & & & {K}_{Yv}\end{matrix} ] [ \begin{matrix}{θ}_{t} \\ {θ}_{t} \\ {θ}_{t} \\ {θ}_{t}\end{matrix} ] \qquad [ Expression 11 ]$$

Note that: M_{X} is a reliability about the horizontal-direction position X; M_{Y} is a reliability about the depth-direction position Y; M_{Xv} is a reliability about the horizontal-direction velocity Xv; and M_{Yv} is a reliability about the depth-direction velocity Yv. Note that: K_{X} is a Kalman gain about the horizontal-direction position X; K_{Y} is a Kalman gain about the depth-direction position Y; K_{Xv} is a Kalman gain about the horizontal-direction velocity Xv; and K_{Yv} is a Kalman gain about the depth-direction velocity Yv.

Alternatively, the reliability calculation unit 23 may calculate the reliability by weighting at least one of the Mahalanobis distance θₜ and the Kalman gain Kₜ, and then multiplying the Mahalanobis distance θₜ by the Kalman gain Kₜ.

(Step S14: Value Selection Process)

The value selection unit 24 selects a detection value whose reliability calculated in step S13 is the highest among a plurality of detection values calculated on the basis of observation values which are set in step S12 as the observation values obtained by detecting the same object. Having a high reliability means that a value obtained by multiplying a Mahalanobis distance by a Kalman gain is small.

A reliability is used in step S14 when selecting a detection value to be employed from among the plurality of detection values calculated on the basis of the observation values which are set as the observation values obtained by detecting the same object. Therefore, in step S13, the reliability calculation unit 23 not need calculate the reliability by taking each of all sensors as a subject sensor. In step S13, when the plurality of observation values are grouped under one group in step S12, the reliability calculation unit 23 only need to calculate the reliability by taking, as subject sensors, sensors from which the observation values classified under that group have been acquired.

A specific example will be described with referring to FIG. 3.

Assume that a Mahalanobis distance between an observation value X, being an observation value 41 obtained with the LiDAR 34, and an observation value Y, being an observation value 42 obtained with the Radar 35, is equal to or less than the threshold. Hence, in step S12, the merging unit 22 takes the observation X and the observation value Y as having been obtained by detecting the same object, and classifies the observation X and the observation value Y under one group 51.

As the observation value X and the observation value Y are grouped under one group 51, in step S13 the reliability calculation unit 23 takes, as a subject sensor, the LiDAR 34 being a sensor from which the observation value X has been acquired, and calculates a reliability M′ of a detection value M about each detection item. Likewise, the reliability calculation unit 23 takes, as a subject sensor, the Radar 35 being a sensor from which the observation value Y has been acquired, and calculates a reliability N′ of a detection value N about each detection item. In FIG. 3, the reliability M′ and the reliability N′ are calculated by normalizing the value obtained by multiplying the Mahalanobis distance by the Kalman gain to be equal to or more than 0 and equal to or less than 1, and then subtracting the normalized value from 1. Therefore, in FIG. 3, the larger the value, the higher the reliability.

Then, in step S14, regarding the object indicated by the group 51, the value selection unit 24 compares the reliability M′ and the reliability N′ in units of detection items, and selects one having a high reliability between the detection value M and the detection value N. In other words, in the case of the reliability M′ and the reliability N′ illustrated in FIG. 3, the value selection unit 24 selects a detection value N “0.14” for the horizontal-direction position X, a detection value M “20.0” for the depth-direction position Y, a detection value N “−0.12” for the horizontal-direction velocity Xv, and a detection value M “−4.50” for the depth-direction velocity Yv.

***Effect of Embodiment 1***

As described above, the measuring device 10 according to Embodiment 1 calculates the reliability of the detection value using the Mahalanobis distance and the Kalman gain.

The Mahalanobis distance expresses a degree of agreement between a past prediction value and a present observation value. The Kalman gain expresses validity of prediction in time series. Therefore, by calculating the reliability using the Mahalanobis distance and the Kalman gain, it is possible to calculate a reliability considering both a degree of agreement between a past prediction value and a present observation value, and validity of prediction in time series. Namely, it is possible to calculate a reliability considering both real-time information and past time-series information.

The measuring device 10 according to Embodiment 1 selects a detection value having a high reliability in units of detection items. That is, when there are a plurality of sensors that have detected the same object, the measuring device 10 according to Embodiment 1 decides a detection value obtained on the basis of which sensor is to employ, in units of detection items, instead of employing detection values obtained for all detection items on the basis of a certain sensor.

Whether or not a sensor can obtain a detection value accurately varies depending on the detection item and the situation. Hence, it is possible that in some situation, a certain sensor can obtain a detection value accurately for some detection item but cannot obtain a detection value accurately for another detection item. In view of this, a detection value having a high reliability is selected in units of detection items, so that accurate detection values can be obtained for all detection items.

***Other Configurations***

<Modification 1>

In Embodiment 1, the function constituent elements are implemented by software. Alternatively, according to Modification 1, the function constituent elements may be implemented by hardware. Modification 1 will be described regarding differences from Embodiment 1.

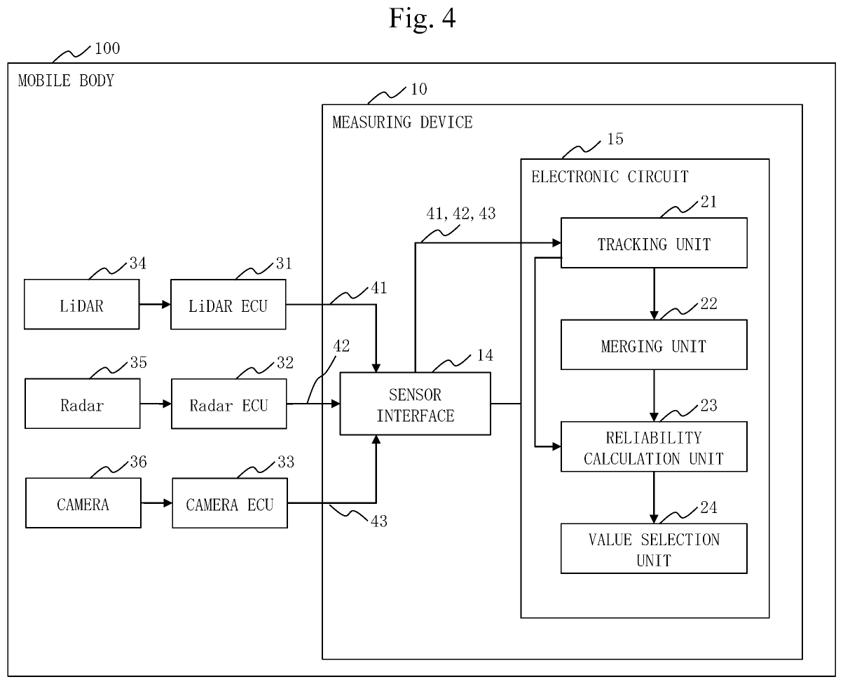

A configuration of a measuring device 10 according to Modification 1 will be described with referring to FIG. 4.

When the function constituent elements are implemented by hardware, the measuring device 10 is provided with an electronic circuit 15 in place of the processor 11, the memory 12, and the storage 13. The electronic circuit 15 is a dedicated circuit that implements functions of the constituent elements and functions of the memory 12 and storage 13.

The electronic circuit 15 is supposed to be a single circuit, a composite circuit, a programmed processor, a parallel-programmed processor, a logic IC, a Gate Array (GA), an Application Specific Integrated Circuit (ASIC), or a Field-Programmable Gate Array (FPGA).

The function constituent elements may be implemented by one electronic circuit 15, or may be implemented by a plurality of electronic circuits 15 through distribution.

<Modification 2>

According to Modification 2, some function constituent elements may be implemented by hardware, and the other function constituent elements may be implemented by software.

The processor 11, the memory 12, the storage 13, and the electronic circuit 15 are called processing circuitry. That is, the functions of the function constituent elements are implemented by processing circuitry.

### Embodiment 2

Embodiment 2 is different from Embodiment 1 in that a mobile body 100 is controlled on the basis of a detection value of a detected object. In Embodiment 2, this difference will be described, and the same point will not be described.

***Description of Configurations***

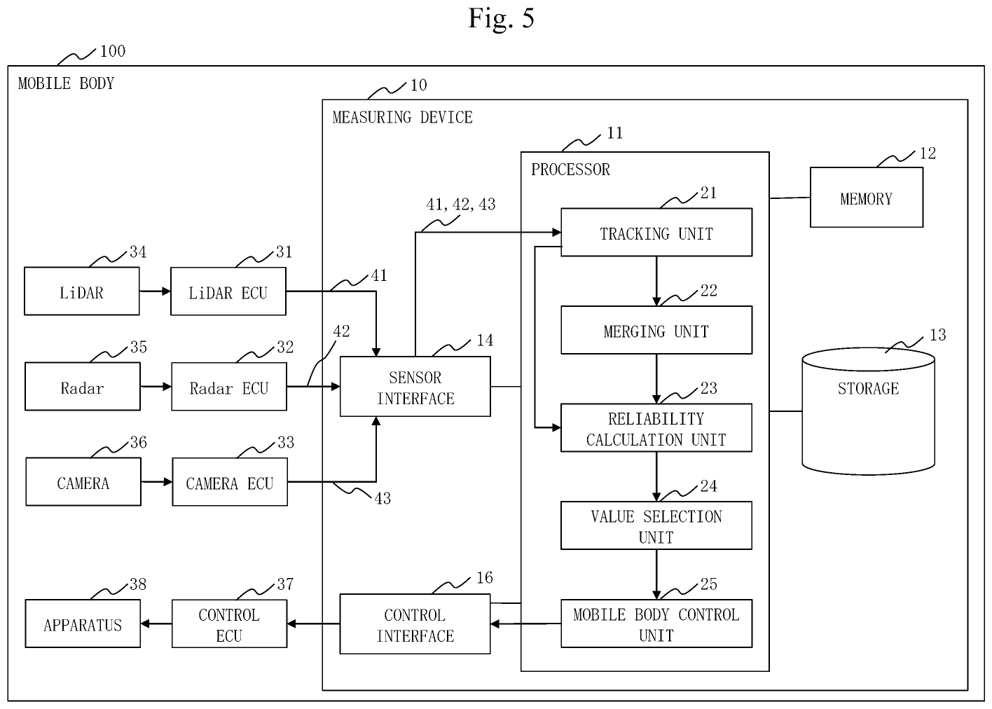

A configuration of a measuring device 10 according to Embodiment 2 will be described with referring to FIG. 5.

The measuring device 10 is provided with a control interface 16 as a hardware device, and in this respect is different from Embodiment 1. The measuring device 10 is connected to a control ECU 37 via the control interface 16. The control ECU 37 is connected to an apparatus 38 such as a brake actuator mounted in the mobile body 100.

The measuring device 10 is also provided with a mobile body control unit 25 as a function constituent element, and in this respect is different from the measuring device 10 illustrated in FIG. 1.

***Description of Operations***

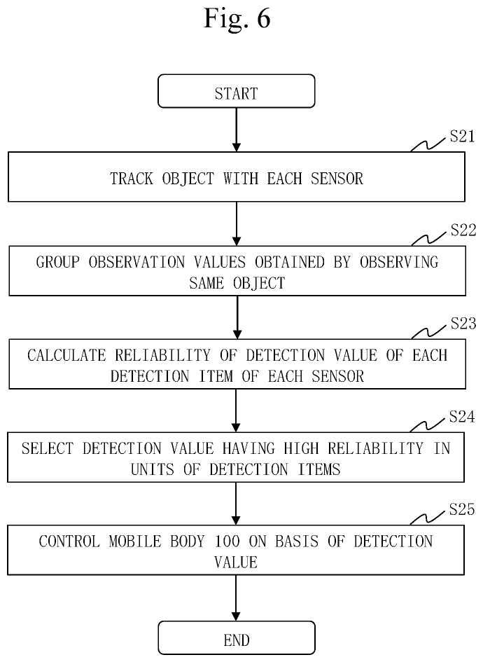

Operations of the measuring device 10 according to Embodiment 2 will be described with referring to FIGS. 6 to 9.

The operations of the measuring device 10 according to Embodiment 2 correspond to a measuring method according to Embodiment 2. The operations of the measuring device 10 according to Embodiment 2 also correspond to processing of a measuring program according to Embodiment 2.

Processes of step S21 to step S24 of FIG. 6 are the same as processes of step S11 to step S14 of FIG. 2.

(Step S25: Mobile Body Control Process)

The mobile body control unit 25 acquires a detection value of each detection item selected in step S24, about an object existing in the vicinity of the mobile body 100. Then, the mobile body control unit 25 controls the mobile body 100.

Specifically, the mobile body control unit 25 controls an apparatus such as a brake and a steering wheel mounted in the mobile body 100 according to a detection value of each detection item about the object existing in the vicinity of the mobile body 100.

For example, the mobile body control unit 25 judges whether or not the mobile body 100 is likely to collide with the object, on the basis of the detection value of each detection item about the object existing in the vicinity of the mobile body 100. If it is judged that the mobile body 100 is likely to collide with the object, the mobile body control unit 25 controls the brake to decelerate or stop the mobile body 100, or controls the steering wheel, to avoid the object.

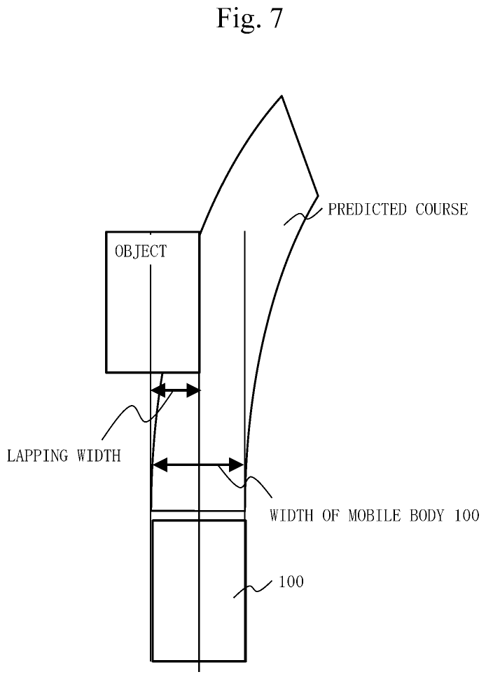

A brake control method will be described as an example of a specific control method with referring to FIGS. 7 to 9.

On the basis of the detection value of each detection item about the object existing in the vicinity of the mobile body 100, the mobile body control unit 25 calculates a lap ratio of a predicted course of the mobile body 100 and the object, and a time to collision (to be referred to as TTC hereinafter). If the TTC is equal to or less than a reference time (for example, 1.6 seconds) with respect to an object having a lap ratio equal to a reference proportion (for example, 50%) or more, the mobile body control unit 25 judges that the mobile body 100 is likely to collide with the object. Then, the mobile body control unit 25 outputs a braking instruction to the brake actuator via the control interface 16 and controls the brake, thereby decelerating or stopping the mobile body 100. The braking instruction to the brake actuator specifically means designating a brake fluid pressure value.

As illustrated in FIG. 7, the lap ratio is a proportion by which the predicted course of the mobile body 100 and the object lap with each other.

The mobile body control unit 25 calculates the predicted course of the mobile body 100 using, for example, Ackerman trajectory calculation. That is, the mobile body control unit 25 calculates a predicted trajectory R by Expression 12 for a vehicle velocity V [meter/second], a yaw rate Yw (angular velocity) [angle/second], a wheel base Wb [meter], and a steering angle St [angle], where the predicted trajectory R is an arc with a turning radius R.

R=1/(α/R₁+(1−α)/R₂) [Expression 12]

Note that: R₁ is a turning radius calculated from a vehicle velocity and an angular velocity and satisfies R₁=V/Yw; R₂ is a turning radius calculated from the steering angle and the wheel base and satisfies R₂=Wb/sin(St); R is a hybrid value of R₁ and R₂; and a is a weighting ratio of R₁ and R₂. When a trajectory calculated from the angular velocity is significant, a is, for example, 0.98.

The collision prediction position according to a change in the predicted course of the mobile body 100, which is based on a factor such as control of the yaw rate and the steering, varies as the time passes. For this reason, if a lap ratio at a certain point is calculated simply and whether or not to perform brake controlling is judged on the basis of a calculation result, sometimes a judgment result is not stable.

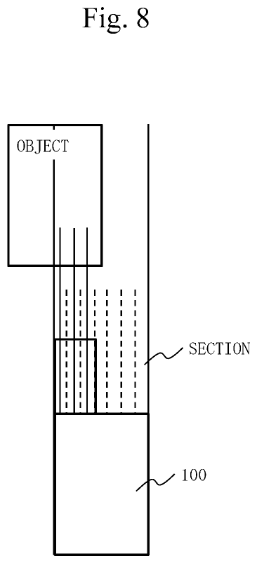

In view of this, the mobile body control unit 25 divides an entire surface of the mobile body 100 into predetermined sections in a lateral direction, as illustrated in FIG. 8, and judges whether or not each section laps with the object. If a number of lapping sections is equal to or more than a reference number, the mobile body control unit 25 judges that the lap ratio is equal to or more than the reference proportion. By doing this, it is possible to stabilize a judgement result to a certain degree.

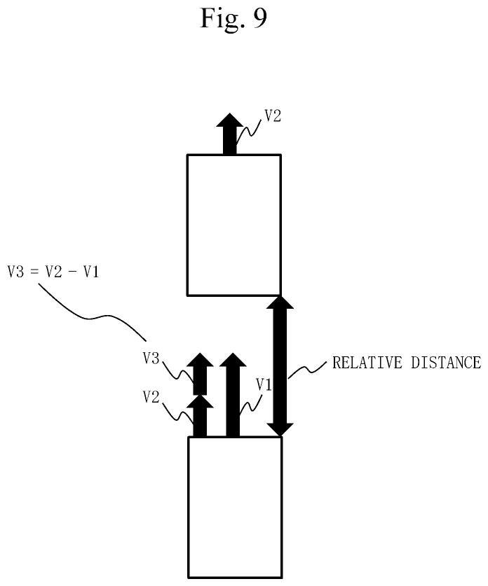

As illustrated in FIG. 9, the mobile body control unit 25 calculates the TTC by dividing a relative distance [meter] of the mobile body 100 to the object by a relative velocity [meter/second]. A relative velocity V3 is calculated by subtracting a velocity V1 of the mobile body 100 from a velocity V2 of the object.

***Effect of Embodiment 2***

As described above, the measuring device 10 according to Embodiment 2 controls the mobile body 100 on the basis of the detection value of each selected detection item of the object. As described in Embodiment 1, the detection value of each detection item has a high accuracy. Therefore, it is possible to control the mobile body 100 appropriately.

### Embodiment 3

Embodiment 3 is different from Embodiment 1 in a reliability calculation method. In Embodiment 3, this difference will be described, and the same point will not be described.

***Description of Operations***

In Embodiment 3, a reliability calculation unit 23 calculates a reliability upon given with one of a Mahalanobis distance θ₁ and a Kalman gain Kₜ in step S13 of FIG. 2, as a weight to a value obtained from the other. That is, the reliability calculation unit 23 calculates a reliability M using the Mahalanobis distance θ₁ and the Kalman gain Kₜ, as indicated by Expression 13 or 14.

M=Kₜ·g(θₜ) [Expression 13]

Note that g(θₜ) is a value obtained from the Mahalanobis distance θ₁.

M=θₜ·h(Kₜ) [Expression 14]

Note that h(Kₜ) is a value obtained from the Kalman gain Kₜ.

According to a specific example, the reliability calculation unit 23 calculates a reliability of a detection value of the detection item of the object, the detection value being calculated on the basis of an observation value by the subject sensor, by multiplying a monotonically decreasing function f(θₜ) of the Mahalanobis distance θₜ by the Kalman gain Kₜ, as indicated by Expression 15.

$$[ \begin{matrix}{M}_{X} \\ {M}_{Y} \\ {M}_{Xv} \\ {M}_{Yv}\end{matrix} ] = [ \begin{matrix}{K}_{X} & & & \\ & {K}_{Y} & & \\ & & {K}_{Xv} & \\ & & & {K}_{Yv}\end{matrix} ] [ \begin{matrix}f ( {θ}_{t} ) \\ f ( {θ}_{t} ) \\ f ( {θ}_{t} ) \\ f ( {θ}_{t} )\end{matrix} ] \qquad [ Expression 15 ]$$

The reliability calculation unit 23 may calculate the reliability by weighting at least one of the monotonically decreasing function f(θₜ) of the Mahalanobis distance θₜ and the Kalman gain Kₜ, and then multiplying the monotonically decreasing function f(θₜ) of the Mahalanobis distance θₜ by the Kalman gain Kₜ.

For the purpose of normalization, as the monotonically decreasing function f(θₜ) of the Mahalanobis distance θₜ, an integrand such as a Lorenz function, a Gaussian function, an exponential function, and a power function may be employed, in which a definite integral, whose integration section of the Mahalanobis distance θₜ is infinite, converges. The monotonically decreasing function f(θₜ) may include a parameter necessary for the calculation.

***Effect of Embodiment 3***

As described above, the measuring device 10 according to Embodiment 3 calculates the reliability when it is given with one of the Mahalanobis distance θₜ and the Kalman gain Kₜ as a weight to a value obtained from the other.

Hence, an appropriate reliability is calculated. As a result, an appropriate detection value is employed.

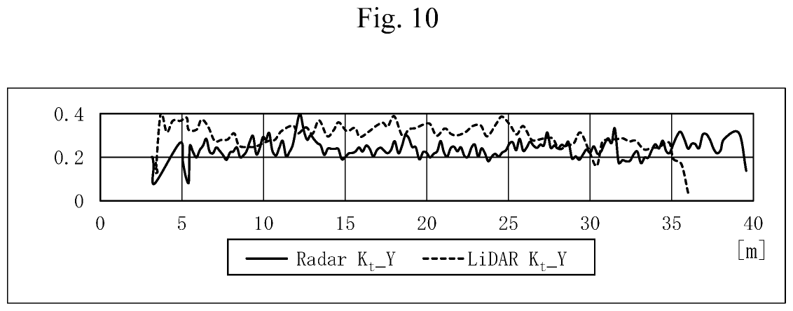

A specific example will be described with referring to FIGS. 10 to 13, in which a detection value is selected by using the reliability calculation method described in Embodiment 3.

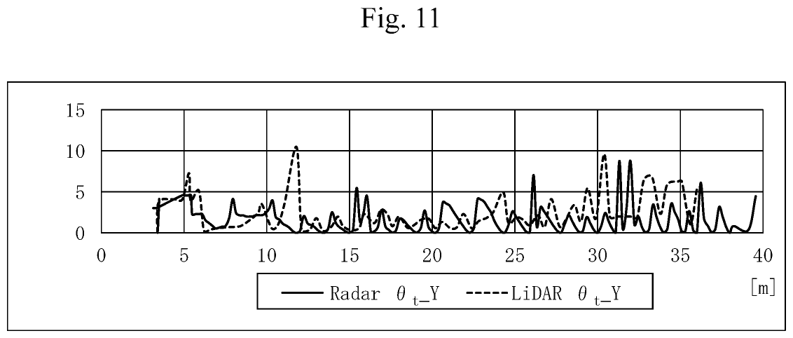

Assume that an observation value obtained with a LiDAR 34 and an observation value obtained with a Radar 35 belong to the same group. In FIG. 10, the axis of abscissa represents a distance of a mobile body 100 to an object existing in the vicinity, and the axis of ordinate represents a Kalman gain related to a relative depth-direction position Y of the object which is obtained with each sensor. In FIG. 11, the axis of abscissa represents a distance of the mobile body 100 to an object existing in the vicinity, and the axis of ordinate represents a Mahalanobis distance concerning a relative depth-direction position Y of an object obtained with each sensor.

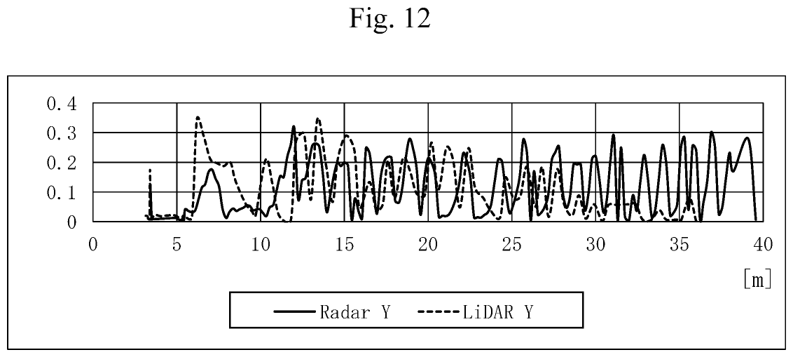

When a reliability about the depth-wise position Y calculated on the basis of the Kalman gain illustrated in FIG. 10 and the Mahalanobis distance illustrated in FIG. 11 is calculated, a result illustrated in FIG. 12 is obtained. Hence, the reliability is calculated by multiplying the monotonically decreasing function f(θt) of the Mahalanobis distance θₜ by the Kalman gain Kₜ. As the monotonically decreasing function f(θt) of the Mahalanobis distance θₜ, a Lorenz function indicated by Expression 16 is used.

ƒ(θₜ)=γ²/θₜ²+γ²) [Expression 16]

As a parameter γ, 1 is used. The parameter γ may be set within a range of 0<γ<∞. The parameter γ may be set such that an influence of the Kalman gain to the reliability increases, or such that an influence of the Mahalanobis distance increases.

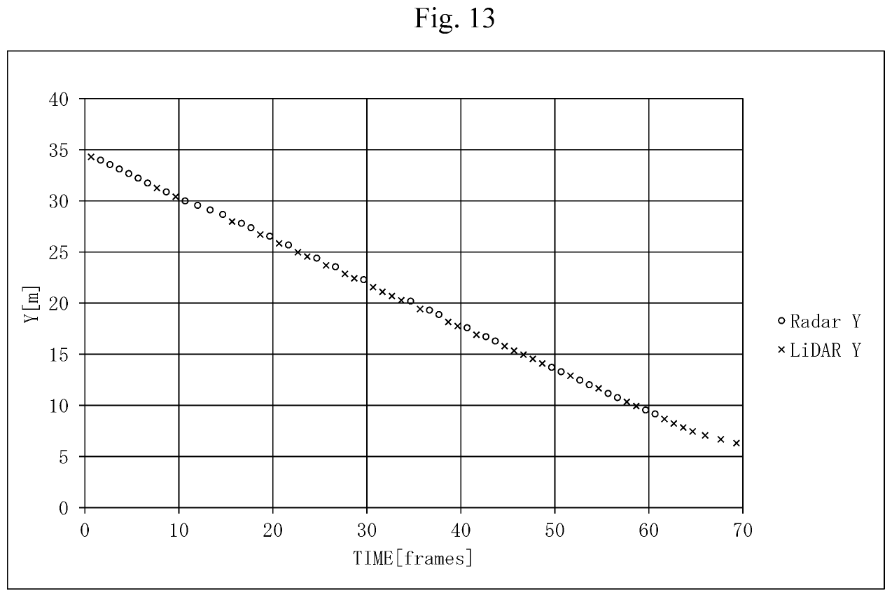

When reliabilities concerning the depth-direction position Y are compared at each time, that is, for each distance with referring to the reliabilities illustrated in FIG. 12, and a detection value having a high reliability is selected, a result illustrated in FIG. 13 is obtained. As illustrated in FIG. 13, the reliability changes constantly as the time passes, with no fluctuation in the depth-direction position Y. This indicates that a highly accurate result is obtained.

***Other Configurations***

<Modification 3>

The mobile body 100 may be controlled as described in Embodiment 2, by using a detection value identified on the basis of the reliability calculated in Embodiment 3.

The embodiments of the present invention have been described. Of these embodiments and modifications, some may be practiced by combination. One or some of these embodiments and modifications may be practiced partly. The present invention is not limited to the above embodiments and modifications, and various changes can be made to the present invention as necessary.

### REFERENCE SIGNS LIST

10: measuring device; 11: processor; 12: memory; 13: storage; 14: sensor interface; 15: electronic circuit; 16: control interface; 21: tracking unit; 22: merging unit; 23: reliability calculation unit; 24: value selection unit; 25: mobile body control unit; 31: LiDAR ECU; 32: Radar ECU; 33: camera ECU; 34: LiDAR; 35: Radar; 36: camera; 37: control ECU; 38: apparatus; 41: observation value; 42: observation value; 43: observation value; 51: group; 100: mobile body.

1. A measuring device comprising:
processing circuitry
to take, as a subject sensor, each of a plurality of sensors, and to calculate a detection value at a subject time about a detection item of an object by using a Kalman filter, on a basis of an observation value about the detection item of the object, the observation value being obtained by observing the object with the subject sensor at the subject time,
to take, as a subject sensor, each of the plurality of sensors, and to calculate a reliability of the detection value that is calculated on the basis of the observation value obtained with the subject sensor, by using a Kalman gain in addition to a Mahalanobis distance between the observation value and a prediction value, upon given with one of the Mahalanobis distance and the Kalman gain, as a weight to a value obtained from the other, the observation value being obtained with the subject sensor, the prediction value being a value of the detection item of the object at the subject time which is predicted at a time before the subject time, the prediction value being used in calculation of calculating the detection value on the basis of the observation value, the Kalman gain being obtained in the calculation, and
to select a detection value whose calculated reliability is high among the detection values which are calculated on the basis of the observation values obtained by the plurality of sensors.

2. The measuring device according to claim 1,
wherein the processing circuitry
takes, as a subject detection item, each of a plurality of detection items of the object which are each obtained by observing the object with the subject sensor at a subject time, and calculates a detection value of the subject detection item about the object on the basis of an observation value about the subject detection item,
takes, as a subject detection item, each of the plurality of detection items, and calculates a reliability of the detection value of the subject detection item, the detection value being calculated on the basis of the observation value which is obtained with the subject sensor, by using a Kalman gain obtained in the calculation, in addition to a Mahalanobis distance between the observation value of the subject detection item and a prediction value of the subject detection item of the object, upon given with one of the Mahalanobis distance and the Kalman gain, as a weight to a value obtained from the other, the observation value being obtained with the subject sensor, and
takes, as a subject detection item, each of the plurality detection items, and selects a detection value whose calculated reliability is high among the detection values which are calculated on the basis of the observation values obtained about the subject detection item with the plurality of sensors.

3. The measuring device according to claim 1,
wherein the processing circuitry calculates the reliability by multiplying the Mahalanobis distance and the Kalman gain.

4. The measuring device according to claim 1,
wherein the processing circuitry calculates the reliability by multiplying a monotonically decreasing function of the Mahalanobis distance by the Kalman gain.

5. The measuring device according to claim 4,
wherein the processing circuitry calculates the reliability by multiplying one of a Lorenz function, a Gaussian function, an exponential function, and a power function, of the Mahalanobis distance by the Kalman gain.

6. The measuring device according to claim 1,
wherein the processing circuitry
calculates the Mahalanobis distances among the observation values obtained with the plurality of sensors individually, and classifies observation values, about which the calculated Mahalanobis distances are equal to a threshold or less, under the same group as being observation values obtained by observing the same object, and
selects a detection value whose reliability is high among the detection values calculated on the basis of the observation values which are classified under the same group.

7. The measuring device according to claim 1,
wherein the object is an object existing in a vicinity of the mobile body, and
wherein the processing circuitry controls the mobile body on the basis of the selected detection value.

8. A measuring method comprising:
taking, as a subject sensor, each of a plurality of sensors, and calculating a detection value at a subject time about a detection item of an object by using a Kalman filter, on a basis of an observation value about the detection item of the object, the observation value being obtained by observing the object with the subject sensor at the subject time;
taking, as a subject sensor, each of the plurality of sensors, and calculating a reliability of the detection value that is calculated on the basis of the observation value obtained with the subject sensor, by using a Kalman gain in addition to a Mahalanobis distance between the observation value and a prediction value, upon given with one of the Mahalanobis distance and the Kalman gain, as a weight to a value obtained from the other, the observation value being obtained with the subject sensor, the prediction value being a value of the detection item of the object at the subject time which is predicted at a time before the subject time, the predicted value being used in calculation of calculating the detection value on the basis of the observation value, the Kalman gain being obtained in the calculation; and
selecting a detection value whose calculated reliability is high among the detection values which are calculated on the basis of the observation values obtained by the plurality of sensors.

9. A non-transitory computer-readable medium storing a measuring program which causes a computer to function as a measuring device that performs:
a tracking process of taking as a subject sensor, each of a plurality of sensors, and calculating a detection value at a subject time of a detection item about an object by using a Kalman filter, on the basis of an observation value of the detection item about the object, the observation value being obtained by observing the object with the subject sensor at the subject time;
a reliability calculation process of taking, as a subject sensor, each of the plurality of sensors, and calculating a reliability of the detection value that is calculated on the basis of the observation value obtained with the subject sensor, by using a Kalman gain in addition to a Mahalanobis distance between the observation value and a prediction value, upon given with one of the Mahalanobis distance and the Kalman gain, as a weight to a value obtained from the other, the observation value being obtained with the subject sensor, the prediction value being a value of the detection item of the object at the subject time which is predicted at a time before the subject time, the prediction value being used in calculation of calculating the detection value by the tracking process on the basis of the observation value, the Kalman gain being obtained in the calculation; and
a value selection process of selecting a detection value whose reliability calculated by the reliability calculation process is high among the detection values which are calculated on the basis of the observation values obtained by the plurality of sensors.
